(19) United States
(12) Patent Application Publication
(10) Pub. No.: US 2018/0275693 A1
(43) Pub. Date: Sep. 27, 2018

(54) SEWER BYPASS SYSTEMS AND METHODS

(71) Applicant: Jet Line Infrastructure Ltd., Beer Tuvia (IL)

(72) Inventor: Albert AZULAY, Rishon Lezion (IL)

(21) Appl. No.: 15/928,989

(22) Filed: Mar. 22, 2018

(30) Foreign Application Priority Data
Mar. 23, 2017 (IL) 251373

(51) Int. Cl. G05D 7/06; E03F 3/04; E03F 7/02; E03F 5/10

(52) U.S. Cl. CPC G05D 7/0635; E03F 5/107; E03F 7/02; E03F 3/04

(57) ABSTRACT

Disclosed herein, are gravity-based sewer bypass systems and related methods for diverting sewage fluid from an upstream sewer pit to a discharge site lower than the upstream sewer pit, via a pipe including an above-ground portion. A sensor external to the pipe is used to determine the sewage fluid level in the upstream sewer pit and accordingly regulate the outflow of sewage fluid at the discharge site.

### FIELD OF THE INVENTION

The invention, in some embodiments thereof, relates to gravity-based sewer bypass systems and related methods.

### BACKGROUND

A sewer bypass system is used to divert sewage fluid flow from a sewer section (e.g. a tunnel section) of a sewer system, for example, when the sewer section needs to undergo maintenance or malfunction repair works requiring crews to descend into the sewer section.

### SUMMARY

Aspects of the invention, according to some embodiments thereof, relate to gravity-based sewer bypass systems and related methods.

Advantageously, the disclosed systems and methods do not require continuous pumping, thereby improving significantly the durability and robustness thereof and reducing occurrence of blockages due to mechanical obstacles to the flow of sewage fluid which may include solid waste. Moreover, the non-use of pumps reduces electricity consumption after installation to negligible levels (as compared to pump-based systems and methods). The disclosed systems and methods are therefore environmentally friendly.

The disclosed systems and methods are siphon-based. Due to the unforeseen nature (e.g. rates) of sewage flows in sewer systems (and since the flow of sewage will not normally be stopped for e.g. maintenance works), the sewage fluid flow through the sewer bypass pipe(s) is regulated in real-time (or near real-time) by control loop to prevent sewage fluid overflows and at the same time to maintain the siphon operational (e.g. prevent entry of air thereinto).

Further, the disclosed systems and methods, according to some embodiments thereof, employ no mechanical components which are positioned at least in part within the pipe(s) (except for a flow control valve which can be fully opened), such as pressure valves (which may come into direct contact with, and trap, debris in the sewage fluid), thereby (i) facilitating unimpeded flow of sewage fluid including solid waste through the sewer bypass pipe(s), and (ii) potentially being less prone to malfunction. In particular, the full cross-section of the pipe(s) is unobstructed (when the flow control valve is fully opened), allowing the conveyance of sewage fluids and debris throughout all of the cross-section. The disclosed systems and methods allow for gravity-induced conveyance of sewage fluids through sewer bypass pipes over distances of hundreds of meters or even kilometers.

According to an aspect of some embodiments, there is provided a sewer bypass system for diverting sewage fluid from an upstream sewer pit in a sewer system to a discharge site. The sewer bypass system includes a pipe, a sensor, a controller, and a flow control valve. The pipe includes a pipe inlet end and a pipe outlet end. The pipe is configured to be partially inserted into an upstream sewer pit through a top opening of the upstream sewer pit with the pipe inlet end being submerged in a sewage fluid in the upstream sewer pit, and with the pipe outlet end being positioned at a discharge site, such that the pipe outlet end is lower than a sewage fluid surface in the upstream sewer pit. The sensor is external to the pipe and is configured to measure at least one parameter indicative of a sewage fluid level in the upstream sewer pit. The flow control valve is positioned at, or near, the pipe outlet end, and is configured to allow controllably fluidly connecting and disconnecting the upstream sewer pit to the discharge site. The controller is functionally associated with the sensor and the flow control valve. The controller is configured to (i) receive a measured value of the parameter from the sensor and, based, at least in part, on the measured value, and (ii) regulate the opening and closing of the flow control valve.

According to some embodiments, the sensor is mounted on the exterior of the pipe such as to be positioned within the upstream sewer pit.

According to some embodiments, the flow control valve is lower than the sewage fluid surface in the upstream sewer pit.

According to some embodiments, the sensor is a level sensor mounted above the sewage fluid.

According to some embodiments, the sensor is an ultrasonic sensor or an optic distance sensor, configured to measure the distance therefrom to the sewage fluid.

According to some embodiments, the sensor is a laser sensor.

According to some embodiments, the sensor is a camera, an infrared camera, or an RF sensor.

According to some embodiments, the controller is configured to compute a difference between a value of the sewage fluid level, indicated by the measured value of the parameter, and a desired or pre-determined value of the sewage fluid level. The controller is further configured to regulate a degree of opening/closing of the flow control valve such as to maintain the degree of opening/closing correlated with the computed difference; or the controller is further configured to, if the computed difference reaches or crosses a threshold difference, command the flow control valve to modify the degree of opening/closing thereof.

According to some embodiments, the controller is configured to compute a rate of change in the sewage fluid level from sequentially measured values of the parameter. The controller is further configured to regulate a degree of opening/closing of the flow control valve as a function of the computed rate of change; or the controller is further configured to, if the computed rate of change reaches or crosses a threshold rate of change, command the flow control valve to modify the degree of opening/closing thereof.

According to some embodiments, the flow control valve includes an actuator, configured to regulate the opening and closing of a valve member of the flow control valve. The controller is configured to instruct the actuator to open the valve member as a function of a difference between the measured sewage fluid level and a lower threshold level such that a degree of opening of the valve member increases with the difference, and (i) if the sewage fluid level drops to, or below, the lower threshold level, the valve member is shut, and (ii) if the sewage fluid level rises to, or above, an upper threshold level, the valve member is fully opened.

According to some embodiments, the sensor is configured to repeatedly measure the parameter indicative of the sewage fluid level.

According to some embodiments, the sensor is configured to continuously monitor the parameter indicative of the sewage fluid level.

According to some embodiments, the discharge site is located in a downstream sewer pit of the sewer system.

According to some embodiments, when the flow control valve is fully open, a full cross-section of the pipe is fully unblocked or substantially fully unblocked.

According to some embodiments, the sewer bypass system further includes a blocking member mounted in the sewer system such as to prevent flow of the sewage fluid from the upstream sewer pit downstream along the sewer system.

According to some embodiments, a bottom section of the upstream sewer pit is connected to a tunnel section of the sewer system leading downstream from the upstream sewer pit. The blocking member is mounted in the tunnel section, optionally at an upstream end of the tunnel section.

According to some embodiments, the pipe is configured for conveying sewage fluids including solid waste.

According to some embodiments, the pipe includes one or more fill openings configured to allow filling the pipe with fluid when the flow control valve is closed.

According to some embodiments, the pipe includes one or more gas-release valves configured for removing gas from the pipe.

According to some embodiments, the sewer bypass system further includes communication cables allowing communication, or one-way communication, between the sensor and the controller and/or the controller and the flow control valve.

According to some embodiments, the communication between the sensor and the controller and/or the controller and the flow control valve is wireless.

According to some embodiments, the controller includes two control modules: a first control module, located near or in the upstream sewer pit, and a second control module, located near or at the discharge site. The control modules are wirelessly communicatively associated. The first control module is functionally associated with the sensor and the second control module is functionally associated with the flow control valve.

According to some embodiments, the pipe includes an above-ground portion.

According to an aspect of some embodiments, there is provided a method for diverting sewage fluid from an upstream sewer pit in a sewer system to a discharge site. The method includes steps of:
Establishing a controllable fluid connection between an upstream sewer pit and a discharge site, via a pipe, partially inserted into the upstream sewer pit through a top opening of the upstream sewer pit, with a pipe inlet end being submerged in a sewage fluid in the upstream sewer pit, and with a pipe outlet end being positioned at the discharge site, such as to be lower than a sewage fluid level in the upstream sewer pit.
Measuring at least one parameter indicative of the sewage fluid level in the upstream sewer pit using a sensor external to the pipe.
Regulating an outflow of the sewage fluid from the pipe outlet end based, at least in part, on one or more measured values of the parameter, wherein the sewage fluid is gravity-conveyed from the upstream sewer pit.

According to some embodiments of the method, the outflow of the sewage fluid from the pipe outlet end is regulated by a controller-commanded flow control valve, and the sensor is configured to send measurement data of the at least one parameter to a controller which commands the flow control valve.

According to some embodiments of the method, the flow control valve is lower than the sewage fluid level in the upstream sewer pit.

According to some embodiments of the method, the method further includes a step of preventing a downstream flow of the sewage fluid from the upstream sewer pit along the sewer system.

According to some embodiments of the method, the method further includes, subsequently to the step of establishing a controllable fluid connection, a step of filling the pipe with a fluid, such as to allow gravity-induced flow of the sewage fluid in the upstream sewer pit to the discharge site.

According to some embodiments of the method, the step of measuring the at least one parameter and the step of regulating the outflow are performed repeatedly.

According to some embodiments of the method, the step of measuring the at least one parameter and the step of regulating the outflow are performed continuously.

According to some embodiments of the method, the sensor is a level sensor mounted above the sewage fluid.

According to some embodiments of the method, the sensor is a distance sensor and the parameter is a distance between the sensor and the sewage fluid level in the upstream sewer pit.

According to some embodiments of the method, the sensor is an ultrasonic sensor or a laser sensor.

According to some embodiments of the method, the discharge site is a downstream sewer pit at a downstream end of the tunnel section.

According to some embodiments of the method, the step of regulating the outflow, includes computing a difference between a value of the sewage fluid level, indicated by the measured value of the parameter, obtained in the step of measuring the parameter, and a desired or pre-determined value of the sewage fluid level. The outflow is determined based, at least in part, on the computed difference.

According to some embodiments of the method, the step of regulating the outflow includes computing a rate of change in the sewage fluid level from sequentially measured values of the parameter, obtained in repetitions, or continuous effecting, of the step of measuring the parameter. The outflow is determined based, at least in part, on the computed rate of change.

According to some embodiments of the method, the step of regulating the outflow includes computing the sewage fluid level from the measured value of the parameter in the step of measuring the parameter. The flow control valve is commanded to open as a function of a difference between the computed sewage fluid level and a lower threshold level such that a degree of opening of the flow control valve increases with the difference, and (i) if the sewage fluid level drops to, or below, the lower threshold level, the flow control valve is closed (so that sewage fluid does not flow from the upstream sewer pit to the discharge site), and (ii) if the sewage fluid level rises to, or above, an upper threshold level, the flow control valve is fully opened.

According to some embodiments of the method, the outflow of sewage fluid in the discharge site is determined according to the difference between the computed sewage fluid level and a lower threshold level, when the sewage fluid level is between the lower threshold level and the upper threshold level.

According to an aspect of some embodiments, there is provided a sewer bypass system for diverting sewage fluid from an upstream sewer pit in a sewer system to a discharge site. The sewer bypass system includes a pipe, a sensor, a controller, and a flow control valve. The pipe extends from the upstream sewer pit to the discharge site. The pipe is configured as a siphon for allowing gravity-induced conveyance of sewage fluid from the upstream sewer pit, and via an above-ground portion of the pipe, to a discharge site lower than the upstream sewer pit. The sensor is external to the pipe and is configured to measure at least one parameter indicative of a sewage fluid level in the upstream sewer pit. The flow control valve is positioned at, or near, a pipe outlet end at the discharge site, and is configured to allow controllably fluidly connecting and disconnecting a pipe inlet end, in the upstream sewer pit, to the pipe outlet end. The controller is functionally associated with the sensor and the flow control valve. The controller is configured to (i) receive a measured value of the parameter from the sensor and, based, at least in part, on the measured value, (ii) regulate the opening and closing of the flow control valve.

According to an aspect of some embodiments, there is provided a method for diverting sewage fluid from an upstream sewer pit in a sewer system to a discharge site. The method includes the steps of:
Establishing a controllable fluid connection between the upstream sewer pit and the discharge site, which is lower than the upstream sewer pit, via a pipe configured as a siphon and which includes an above-ground portion.
Measuring at least one parameter indicative of a sewage fluid level in the upstream sewer pit using a sensor external to the pipe.
Regulating outflow of the sewage fluid from the pipe outlet end based, at least in part, on one or more measured values of the parameter, wherein the sewage fluid is gravity-conveyed from the upstream sewer pit.

Certain embodiments of the present invention may include some, all, or none of the above advantages. Further advantages may be readily apparent to those skilled in the art from the figures, descriptions, and claims included herein. Aspects and embodiments of the invention are further described in the specification hereinbelow and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

Israeli Patent Application no. 251373 to A. Azulay is incorporated herein by reference in its entirety.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1 schematically depicts a sewer system;

FIG. 2a schematically depicts the sewer system of FIG. 1 and a sewer bypass system installed such as to divert sewage flow from a tunnel section of the sewer system, according to some exemplary embodiments;

FIG. 2b schematically depicts the sewer system of FIG. 1 and a sewer bypass system installed such as to divert sewage flow from a tunnel section of the sewer system, according to some exemplary embodiments;

FIG. 2c schematically depicts the sewer system of FIG. 1 and a sewer bypass system installed such as to divert sewage flow from a tunnel section of the sewer system, according to some exemplary embodiments; and

FIG. 3 is a flowchart of a method for diverting sewage flow from an upstream sewer pit of a sewer system to a discharge site, according to some exemplary embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include”, “have”, and forms thereof, are not necessarily limited to members in a list with which the words may be associated.

As used herein, the term “about” is used to specify a value of a quantity or parameter (e.g. the length of an element) to within a continuous range of values in the neighborhood of (and including) a given (stated) value. According to some embodiments, “about” specifies the value of a parameter to be between 80% and 120% of the given value. For example, the statement “the length of the element is equal to about 1 m” is equivalent to the statement “the length of the element is between 0.8 m and 1.2 m”. According to some embodiments, “about” specifies the value of a parameter to be between 90% and 110% of the given value. According to some embodiments, “about” specifies the value of a parameter to be between 95% and 105% of the given value.

### Systems

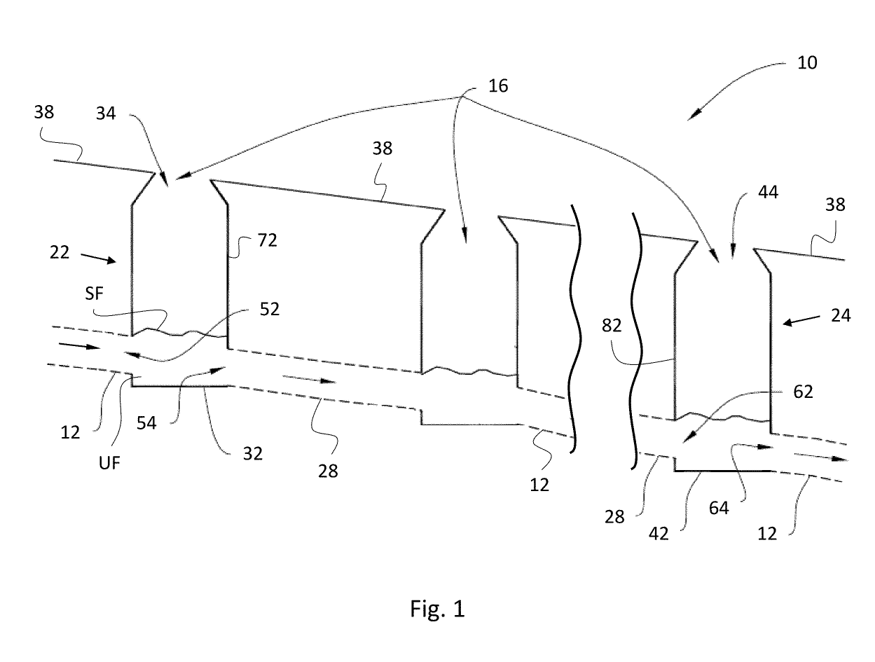

FIG. 1 schematically depicts a sewer system 10. Sewer system 10 includes a tunnel 12 (defining a gradient), for gravity-based conveying of sewage fluids, and sewer pits 16. Sewer pits 16 provide access to tunnel 12, e.g. for maintenance crews. Sewer pits 16 include an upstream sewer pit 22 and a downstream sewer pit 24, which are (fluidly) connected via at least one tunnel section 28 of tunnel 12.

More specifically, upstream sewer pit 22 includes an upstream sewer pit bottom section 32, and an upstream sewer pit top opening 34 (e.g. a manhole or even a larger opening, as elaborated on below) providing access from above-ground (e.g. from a pavement 38) to upstream sewer pit 22. Downstream sewer pit 24 includes a downstream sewer pit bottom section 42, and a downstream sewer pit top opening 44 providing access from above-ground to downstream sewer pit 24. Upstream sewer pit bottom section 32 includes a sewage fluid inlet 52 and a sewage fluid outlet 54. Downstream sewer pit bottom section 42 includes a sewage fluid inlet 62 and a sewage fluid outlet 64. Tunnel section 28 extends from upstream sewer pit bottom section 32 to downstream sewer pit bottom section 42.

According to some embodiments, sewer system 10 is a combined sewer and one or more of sewer pits 16 is a drainage pit.

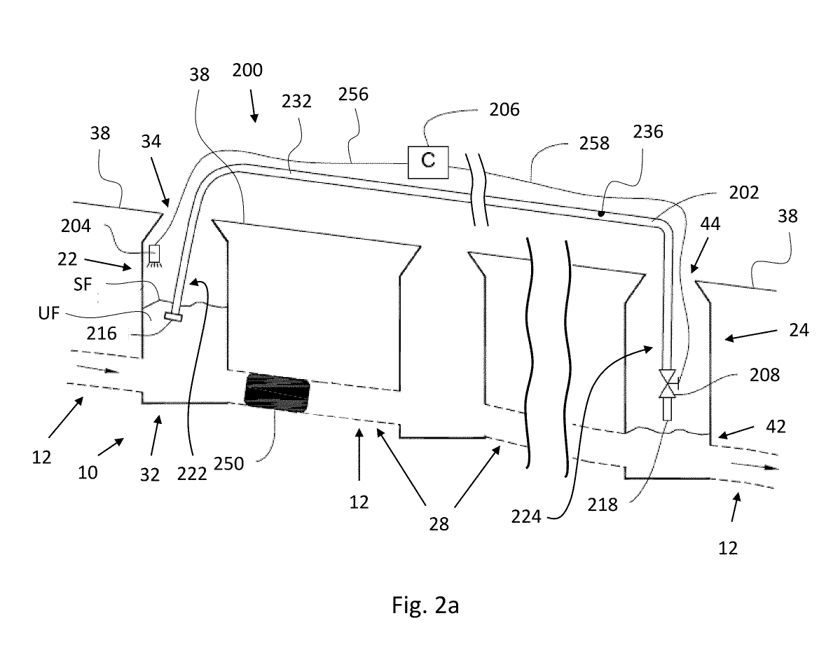

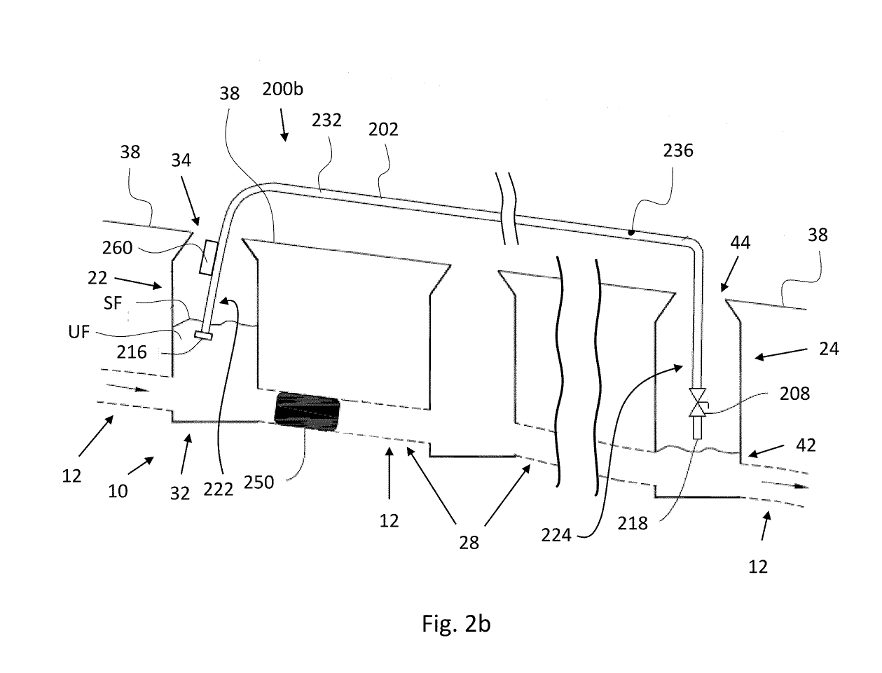

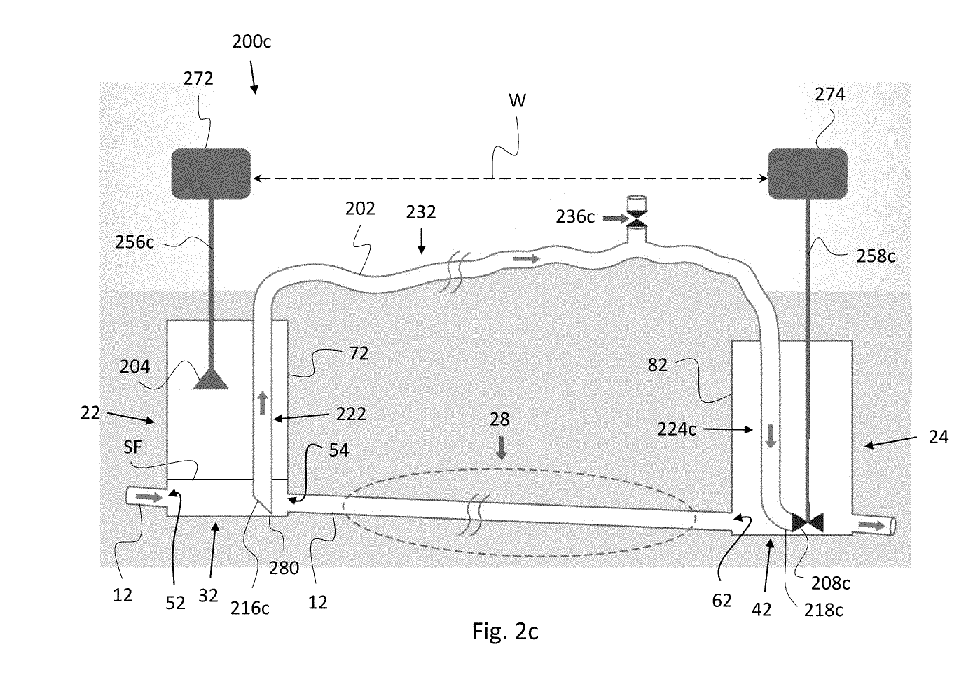

FIG. 2a schematically depicts sewer system 10 and a sewer bypass system 200. Sewer bypass system 200 is shown installed such as to provide a sewer bypass to convey (transfer) sewage fluid from upstream sewer pit 22 to downstream sewer pit 24 while sewage flow through tunnel section 28 is prevented (e.g. for the purpose of malfunction repair). Sewer bypass system 200 includes a pipe 202, a sensor 204, a controller 206, and a flow control valve 208. Pipe 202 includes a pipe inlet end 216 and a pipe outlet end 218. A first sewer-insertable portion 222 of pipe 202 (first sewer-insertable portion 222 includes pipe inlet end 216) is inserted into upstream sewer pit 22 such that pipe inlet end 216 is submerged in a sewage fluid UF in upstream sewer pit 22. A second sewer-insertable portion 224 of pipe 202 (second sewer-insertable portion 224 includes pipe outlet end 218) is inserted into downstream sewer pit 24, such that pipe outlet end 218 is positioned lower than a level of sewage fluid UF. (So that pipe 202 is configured to function as a siphon for transferring sewage fluid from upstream sewer pit 22 to downstream sewer pit 24.) An above-ground portion 232 of pipe 202 extends between first sewer-insertable portion 222 and second sewer-insertable portion 224. Above-ground portion 232 may be configured to be installable over changing (non-flat) terrain (essentially as depicted in FIG. 2c) and city topographies and, if need be, to circumvent obstacles (e.g. buildings) on route above-ground between sewer pits 22 and 24.

As used herein, according to some embodiments, a “level” (or “fluid level”) of a fluid refers to a height of a (top) surface of the fluid. In FIGS. 1-2c, a sewage fluid surface of sewage fluid UF is designated by SF.

It is noted that sewer pit openings 34 and 44 may be manholes or other types of openings, particularly, openings larger than manholes (manholes typically having a diameter of about 80 cm) created e.g. by lifting the respective pavements above (and exposing the full cross sections of) sewer pits 22 and 24, such as to allow insertion of pipes having diameters greater than typical of manholes.

According to some embodiments, above-ground portion 232 includes at least one fill opening 236 configured for filling pipe 202 with fluid (e.g. using an external fluid source or via suction) at sewer bypass system 200 initiation after installation thereof, so as to facilitate gravity-induced sewage fluid flow from upstream sewer pit 22 to downstream sewer pit 24 (via pipe 202).

According to some embodiments, pipe 202 includes one or more gas-release valves configured for removing gas from inside pipe 202. According to some embodiments, fill opening 236 is also configured for gas release.

According to some embodiments, sewer bypass system 200 further includes a blocking member (plug) 250. Blocking members are known in the art: the sewer sealing cushion from LAMPE being an example. Blocking member 250 is configured to be mounted in tunnel section 28 such as to prevent flow therethrough of sewage fluid from upstream sewer pit 22 to downstream sewer pit 24. When blocking member 250 blocks tunnel section 28 and pipe 202 is filled with fluid, the positioning of pipe outlet end 218, such as to be lower than sewage fluid surface SF (and lower than pipe inlet end 216), causes sewage fluid UF to flow from upstream sewer pit 22 to downstream sewer pit 24, as further elaborated on below.

Pipe 202 is configured to facilitate conveying sewage fluid, including also solid waste (such as offal, grit, sand, stones, rags, twigs, branches, wipes, pads, diapers, fats and grease, etc.), therethrough. Pipe 202 will generally have a diameter similar to, or slightly smaller than, a diameter of tunnel section 28, for example, 0.9 m when the diameter of tunnel section 28 is 1.0 m.

According to some embodiments, second sewer-insertable portion 224 is longer than first sewer-insertable portion 222. According to some embodiments, first sewer-insertable portion 222 can be as long as about 10 m.

The skilled person will understand that sewer bypass system 200 can be used also in diverting sewage flow from a section of a sewer system to a discharge site which is not a sewer pit. For example, the discharge site may be a sewage reservoir or a wastewater treatment plant (WWTP), as long as a bottom section of the discharge site is lower than the surface of the sewage fluid in a sewer diversion location (e.g. upstream sewer pit 22) in the sewer system.

Sensor 204 is positioned externally to (outside of) pipe 202 and is configured to measure a parameter indicative of the sewage fluid level in upstream sewer pit 22, and to send the obtained measurement data (measured value(s)) to controller 206. According to some embodiments, sensor 204 is mounted above sewage fluid UF (and does not come into contact with sewage fluid UF). According to some embodiments, sensor 204 is mounted within upstream sewer pit 22, e.g. on a wall of upstream sewer pit 22. According to some embodiments, sensor 204 is mounted on the exterior of first sewer-insertable portion 222.

Advantageously, being positioned outside of pipe 202, sensor 204 does not include any components that can hinder the sewage fluid flow inside pipe 202 and induce clogging of pipe 202 (e.g. components positioned fully, or in part, within pipe 202 and on which sewer solid waste, such as pads or branches, may be trapped, thereby obstructing sewage fluid flow in pipe 202).

According to some embodiments, sensor 204 is sensitive to changes of at least about 1 cm in the sewage fluid level. According to some embodiments, sensor 204 is configured for repeated measurements, e.g. at intervals of 1 sec, 0.1 sec, 0.01 sec, or even 1 msec. According to some embodiments, e.g. when sensor 204 is an ultrasonic sensor, sensor 204 reaction time to a sufficiently large change (e.g. a change of at least about 1 cm) in the sewage fluid level is at most about 1 msec (that is, it takes no more than at most about 1 msec for sensor 204 to register a sufficiently large change in the sewage fluid level). According to some embodiments, sensor 204 is configured for continuous monitoring of the sewage fluid level effected via continuous measurement of the indicative parameter. As used herein, according to some embodiments, the term “continuous measurement” with reference to measurements of a sewage fluid level, e.g. in a sewer pit, refers to repeated measurements of the sewage fluid level at intervals of 5 sec or less. As used herein, according to some embodiments, when the time taken for sensor 204 to register a sufficiently large change in the sewage fluid is no greater than 5 sec, sensor 204 may be said to “continuously monitor” the sewage fluid level. According to some embodiments, the terms “continuous measurement” and “continuous monitoring” are used interchangeably.

According to some embodiments, sensor 204 is a level sensor configured to determine the height of the surface of sewage fluid UF. According to some embodiments, sensor 204 is a distance sensor, being configured to measure the distance between sensor 204 and the surface of sewage fluid UF. According to some embodiments, sensor 204 is an ultrasonic sensor (as non-limiting examples, see, the ultrasonic level equipment manufactured by Pulsar). According to some embodiments, sensor 204 is an optic sensor, such as a laser-based distance sensor (as non-limiting examples, see the laser level transmitters manufactured by ABB).

According to some embodiments, sensor 204 is submerged in the sewage fluid (but is external to pipe 202). According to some such embodiments, sensor 204 is a pressure sensor.

Flow control valve 208 is positioned in pipe 202 at, or near, pipe outlet end 218, with pipe 202 being installed such that pipe outlet end 218 is lower than the sewage fluid level (i.e. lower than sewage fluid surface SF). Valve 208 is configured to allow fluidly connecting and disconnecting pipe inlet end 216 to pipe outlet end 218 (and consequently upstream sewer pit 22 to downstream sewer pit 24 when tunnel section 28 is blocked). Valve 208 is switchable between at least two states: a first state wherein valve 208 is closed (shut) and a second state wherein valve 208 is fully open (open to the maximum). According to some embodiments, valve 208 is controllably continuously switchable between the first state and the second state, such as to allow regulating a rate of sewage fluid outflow via pipe outlet end 218, as elaborated on below. In particular, when valve 208 is open or partially open, sewage fluid flows via pipe 202 from upstream sewer pit 22 to downstream sewer pit 24. As used herein, according to some embodiments, valve 208 is said to be “continuously switchable” between the first state and the second, when valve 208 can be used to controllably expose pipe outlet end 218 cross-section to a resolution of about 1% of the area defined by the cross-section (that is, valve 208 is switchable between about 100 states defining different degrees of opening of valve 208). Thus, valve 208 may be used to controllably expose, for example, 1%, 2%, 3%, and so on (until 100%), of pipe outlet end 218 cross-section to fluid flow. According to some embodiments, when valve 208 is in the second state, a cross-section of second sewer-insertable portion 224 (at valve 208 installation location) is fully unblocked, thereby allowing unimpeded sewage flow at least through second sewer-insertable portion 224. According to some such embodiments, valve 208 is a gate valve (that is, valve 208 includes a valve member in the form of a gate). According to some such embodiments, when valve 208 is in the second state, a full cross-section of pipe 202 all along pipe 202 is fully unblocked (in particular, pipe 202 includes no mechanical components obstructing sewage flow and on which solid waste can become stuck or trapped), thereby allowing unimpeded sewage flow all along pipe 202.

Controller 206 is functionally associated with sensor 204 and valve 208. Sensor 204, controller 206, and valve 208 constitute a control loop system, as specified below. Controller 206 is configured to receive measurement data (measured value(s) of the parameter indicative of the sewage fluid level in upstream sewer pit 22) from sensor 204. Controller 206 is further configured, based on the measurement data received, to determine if the state of valve 208 should be modified (i.e. opened, closed, opened more, etc.), and, if it is determined that the state should be modified, send instructions to valve 208 to accordingly modify the state thereof. More specifically, valve 208 may include an actuator (e.g. an electric motor) commanded by controller 206. The actuator is configured to regulate the opening and closing of a valve member of valve 208. The valve member can be a gate, a wedge, a sliding part, or the like. Valve 208 may be further configured to send controller 206 information specifying the state of valve 208 (e.g. the degree of opening of the valve member). According to some embodiments, controller 206 is communicatively associated with sensor 204 and valve 208 by communication cables 256 and 258, respectively. Communication cables 256 and 258 can be, for example, electrical cables or optical cables. According to some embodiments, controller 206 is positioned near, or on, above-ground portion 232, being thereby accessible from above-ground. According to some embodiments, controller 206 includes a wireless communication unit configured to allow remote controlling thereof.

Controller 206 includes processing circuitry and a memory. The processing circuitry is configured to process sensor 204 measurement data to regulate the outflow of sewage fluid through pipe outlet end 218, i.e. determine whether the degree of opening of valve 208 should be adjusted, and, if so, then by how much. The processing circuitry may be an application specific integrated circuitry (ASIC), a programmable processing circuitry such as an FPGA, firmware, and/or the like, configured to process measurement data obtained by sensor 204, as explained above. According to some embodiments, the processing circuitry is configured to compare the determined sewage fluid level (as computed from the measured parameter) to a desired sewage fluid level (between a lower threshold level and an upper threshold level) or to a pre-determined sewage fluid level (e.g. a lower threshold level determined by the dimensions of pipe inlet end 216 such as to prevent air from entering pipe inlet end 216 during sewer bypass system operation), stored in the memory, and accordingly regulate the outflow of sewage fluid via valve 208. According to some embodiments, the processing circuitry is configured to compare the determined sewage fluid level (computed from the measured parameter) to one or more previously determined sewage fluid levels, stored in the memory, and accordingly regulate the outflow of sewage fluid via valve 208. According to some embodiments, the processing circuitry is configured to regulate the outflow of sewage fluid via valve 208, based on the determined sewage fluid level and the determined rate of change thereof, as elaborated on below in the Methods subsection.

According to some embodiments, controller 206 is configured to command valve 208 to shut when the sewage fluid level drops to a lower threshold level of e.g. 5 cm above pipe inlet end 216 (in order to prevent air from entering pipe 202 via pipe inlet end 216). Controller 206 is further configured to command valve 208 to fully open when the sewage fluid level rises to an upper threshold level of e.g. 80 cm above pipe inlet end 216 (in order to prevent overflow, or at least to maximally slow the rising, of sewage fluid in upstream sewer pit 22). Values of the threshold levels are stored in the memory. According to some embodiments, the memory is a non-transitory memory. The memory may include a solid-state memory, a magnetic memory, a photonic memory, and/or the like. According to some embodiments, the memory includes both non-transitory memory components and transitory memory components.

According to some embodiments, controller 206 is configured to command valve 208 to open/close according to a computed difference (computed by controller 206) between the measured sewage fluid level and a desired sewage fluid level or a pre-determined sewage fluid level. That is, the degree of opening/closing of valve 208 is set according to the computed difference, when the sewage fluid level is between the lower threshold level and the upper threshold level. According to some embodiments, controller 206 is configured to command valve 208 to maximally open when the computed difference reaches or crosses an upper threshold difference (e.g. a difference between the upper threshold level and the desired or pre-determined sewage fluid level). According to some embodiments, controller 206 is configured to command valve 208 to shut when the computed difference reaches or crosses a lower threshold difference. When the difference is taken with respect to the desired level, the lower threshold difference (being the difference between the lower threshold level and the desired threshold level) will be negative. As a non-limiting example, the more negative the difference, the greater the degree of closing (closing fully when the computed difference reaches or crosses the lower threshold difference). When the difference is taken with respect to the pre-determined level, the lower threshold difference may be zero.

According to some embodiments, controller 206 is configured to command valve 208 to open/close as a function of a determined rate of change (computed by controller 206) in the sewage fluid level. According to some embodiments, controller 206 is configured to command valve 208 to maximally open when the determined rate of change in the sewage fluid reaches or crosses an upper threshold rate of change. According to some embodiments, controller 206 is configured to command valve 208 to shut when the determined rate of change in the sewage fluid level reaches or crosses a lower threshold rate of change.

According to some embodiments, sensor 204 is configured to send a current or voltage signal to controller 206. The amplitude of the current signal may range from a minimum amplitude (e.g. 4 mA) to a maximum amplitude (e.g. 20 mA). The resolution of the current may be, for example, 0.01 mA (so that sensor 204 may be sensitive to changes on the order of 1 cm in the sewage fluid level when upstream sewer pit 22 is about 10 m deep). The amplitude of the current signal is determined by the measured sewage fluid level. When the sewage fluid level equals the lower threshold level or is below the threshold lower level, the amplitude of the current signal is minimum (e.g. 4 mA). When the sewage fluid level equals the upper threshold level or is above the upper threshold level, the amplitude of the current signal is maximum (e.g. 20 mA). The amplitude of the current signal may change linearly with the sewage fluid level when the sewage fluid level is between the lower threshold level and the upper threshold level. Controller 206 may be configured to instruct valve 208 actuator to increase the opening of valve 208 valve member as a function of the amplitude of the current signal received from sensor 204. Thus, valve 208 opening and closing (and consequently the outflow of sewage fluid from pipe outlet end 218 and inflow of sewage fluid through pipe inlet end 216) is regulated according to the sewage fluid level in upstream sewer pit 22 (i.e. according to the difference between the measured sewage fluid level and the lower threshold level). So that, for example, when the sewage fluid level is midway between the lower threshold level and the upper threshold, valve 208 is half open (e.g. 50% of pipe outlet end 218 is exposed to fluid flow).

According to some embodiments, sensor 204 is a camera, or an infrared camera, and controller 206 is configured to determine the sewage fluid level from images obtained from sensor 204. According to some embodiments, sensor 204 is an RF sensor.

According to some embodiments, and as depicted in FIG. 2b, there is provided a sewer bypass system 200b. Sewer bypass system 200b is similar to sewer bypass system 200 but differs therefrom in not including communication cables 256 and 258. Instead, each of sensor 204, controller 206, and valve 208 includes a respective wireless communication unit, e.g. cellular network-based (not shown). (Valve 208 may further be connected by a power cable (not shown) to an external power supply source (not shown) for powering valve 208 operation.) According to some embodiments, and as depicted in FIG. 2b, controller 206 and sensor 204 are located within a common housing 260.

According to some embodiments, and as depicted in FIG. 2c, there is provided a sewer bypass system 200c. Sewer bypass system 200c is similar to sewer bypass system 200 but differs therefrom in that the controller thereof includes two control modules remotely located with respect to one another: a first control module 272 and a second control module 274. Control modules 272 and 274 are wirelessly communicatively associated (as indicated by dashed line W), e.g. via a cellular network or a satellite network. More specifically, first control module 272 is located near, or in, upstream sewer pit 22 and second control module 274 is located near, or in, downstream sewer pit 24, which may be located at a distance of hundreds of meters from one another or even kilometers. According to some embodiments, first control module 272 is functionally associated with sensor 204 via a cable 256c, and second control module 274 is functionally associated with a flow control valve 208c (being a specific embodiment of flow control valve 208) via a cable 258c. Cables 256c and 258c may be braid cables. Cable 256c is configured to transmit sensor 204 measurement data to first control module 272, and, according to some embodiments, to supply power to operate sensor 204. Cable 258c is configured to transmit sensor 204 commands to flow control valve 208c actuator and to send information from the actuator to sensor 204, the information specifying the degree of opening of valve 208c valve member. An additional cable (not shown) may be used to supply power (from an external power source) to operate valve 208c. According to some embodiments, sensor 204, control modules 272 and 274, and valve 208 constitute a closed-loop control system, as specified below.

According to some embodiments, first sewer insertable portion 222 is positioned proximately to a wall 72 including sewage fluid outlet 54, thereby potentially reducing occurrence of turbulence caused by inflow of sewage fluid into upstream sewer pit 22 via sewage fluid inlet 52. First sewer insertable portion 222 may be attached to (mounted on) wall 72 for support. Similarly, according to some embodiments, a second sewer insertable portion 224c (being a specific embodiment of second sewer-insertable portion 224) is positioned proximately to a wall 82 including sewage fluid inlet 62, thereby potentially reducing occurrence of turbulence caused by flow of sewage fluid into downstream sewer pit 24 via a pipe outlet end 218c. Second sewer insertable portion 224 may be attached to (mounted on) wall 82 for support.

According to some embodiments, second sewer-insertable portion 224c is curved near pipe outlet end 218c, such that pipe outlet end 218c cross-section is vertical, and valve 208c is positioned horizontally, thereby potentially reducing occurrence of turbulence caused by flow of sewage fluid into downstream sewer pit 24 via pipe outlet end 218c. According to some such embodiments, an end segment (including valve 208c and pipe outlet end 218c) of second sewer-insertable portion 224c lies on the floor or ground of downstream sewer pit 24.

According to some embodiments, a cross-section of a pipe inlet end 216c (being a specific embodiment of pipe inlet end 216) is slanted. That is, the cross-section defines a plane at an angle of e.g. 45° relative to the floor of upstream sewer pit 22. A tip 280 of pipe inlet end 216c may rest on the floor or ground of upstream sewer pit 22.

According to some embodiments, pipe 202 includes a fill opening 236c (being a specific embodiment of fill opening 236). According to some embodiments, fill opening 236c is configured for air suction. Fill opening 236c may be an open tube (which does not project into pipe 202 cross-section) or may include a non-return valve, a gas-release valve, or a manual valve in the tube configured to prevent air from entering via fill opening 236c.

Blocking member 250 is not shown in FIG. 2c.

### Methods

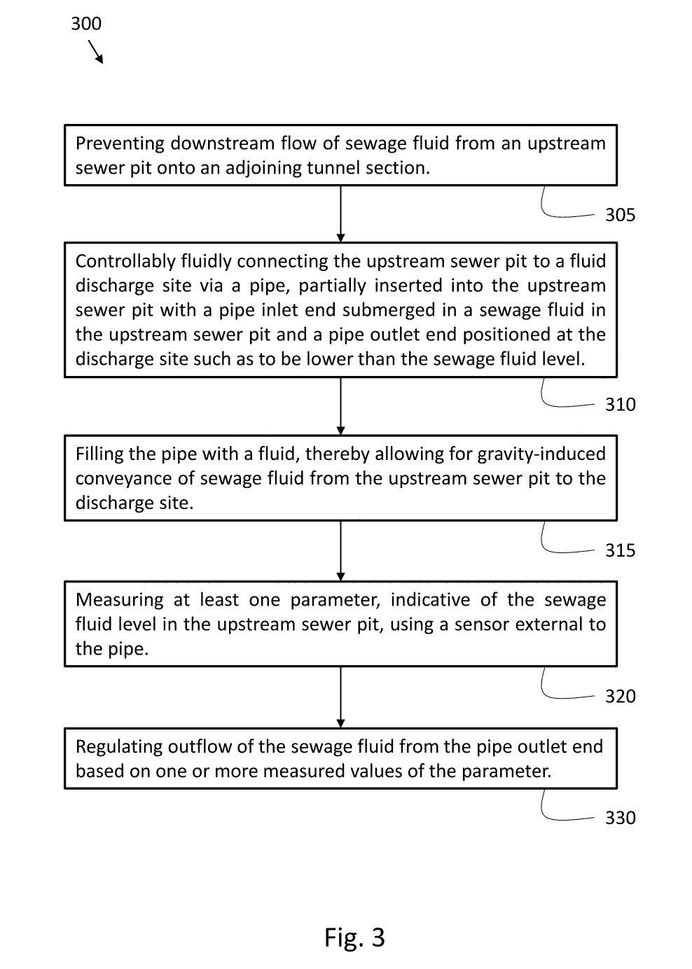

FIG. 3 is a flowchart of a siphon-based method 300 for diverting sewage fluid flow from an upstream sewer pit, such as upstream sewer pit 22, onto a discharge site, such as downstream sewer pit 24 (while preventing flow through a tunnel section of the sewer section connecting the sewer pits) or a sewage reservoir. Method 300 can be implemented using a sewer bypass system, such as sewer bypass system 200, 200b, or 200c, as will be readily apparent to the skilled person who peruses the description. According to some embodiments, method 300 includes the following steps:
A step of 305 of preventing downstream flow of sewage fluid from an upstream sewer pit (such as upstream sewer pit 22) of a sewer system onto an adjoining tunnel section (such as tunnel section 28) downstream from the upstream sewer pit.
A step 310 of controllably fluidly connecting the upstream sewer pit to a fluid discharge site (such as downstream sewer pit 24), via a pipe, such as pipe 202, and which may include an above-ground portion such as above-ground portion 232. The pipe is partially inserted into the upstream sewer pit through an opening at the top of the upstream sewer pit, with a pipe inlet end (e.g. pipe inlet end 216 or 216c) being submerged in a sewage fluid (i.e. the pipe inlet end is below the sewage fluid surface) in the upstream sewer pit, and with a pipe outlet end (e.g. pipe outlet end 218 or 218c) being positioned at the discharge site, such that the pipe outlet end is lower than a sewage fluid level in the upstream sewer pit (e.g. as depicted in FIGS. 2a-2c).
A step 315 of filling the pipe with fluid (e.g. via a fill opening(s) such as fill opening 236 or 236c), thereby allowing for gravity-induced conveyance of sewage fluid from the upstream sewer pit to the discharge site.
A step 320 of measuring at least one parameter, indicative of the sewage fluid level (i.e. the height of the sewage fluid surface) in the upstream sewer pit, using a sensor external to the pipe, such as sensor 204.
A step 330 of regulating outflow of the sewage fluid from the pipe outlet end based, at least in part, on one or more measured values of the parameter.

According to some embodiments, steps 320 and 330 are effected repeatedly. According to some embodiments, steps 320 and 330 are effected continuously, e.g. the sensor takes no more than 5 sec or 1 sec to register a sufficiently large change in the sewage fluid level. According to some embodiments, when the pipe has a diameter of about 1 m, valve 208 may take on the order of 10 sec to fully close starting from a fully open state.

In step 320, the measured parameter may be a distance between the sensor and the sewage fluid surface (when the sensor is a distance sensor). Since the location (and particularly the height) of the sensor is known, the sewage fluid level can be computed from the measured distance. From repeated measurements, or continuous monitoring, the rate of change of the height of the sewage fluid surface can be determined or substantially determined.

In step 330, the outflow of sewage fluid from the pipe outlet end may be regulated using a valve, such as valve 208 or valve 208c. According to some embodiments, the valve is lower than the height of the sewage fluid surface in the upstream sewer pit. The opening and closing of the valve may be controlled by a controller, such as controller 206 or control module 274 (and control module 272), with which the valve is communicatively associated (e.g. by electrical cables or wirelessly).

According to some embodiments, the outflow of sewage fluid through the pipe outlet end is regulated according to the sewage fluid level in the upstream sewer pit (as indicated by the measured parameter), for example, according to the difference between the sewage fluid level and a pre-determined level of the sewage fluid. In particular, the higher the sewage fluid level (between two threshold levels, as explained above in the Systems subsection and further elaborated on below), the greater the degree of opening of the valve. According to some such embodiments, the degree of opening of the valve (e.g. the unblocked portion of the pipe cross-section at, or near, the pipe outlet end) may be continuously, or substantially continuously, modified according to the height of the sewage fluid surface in the upstream sewer pit (so as to maintain the degree of opening of the of the valve in correlation with the difference between the height of the sewage fluid surface and the pre-determined level).

According to some embodiments, the outflow of sewage fluid through the pipe outlet end is based on the sewage fluid level in the upstream sewer pit and the rate of change thereof (e.g. as indicated by sequentially obtained values of the measured parameter). According to some such embodiments, the degree of opening of the valve (and thus the outflow of sewage fluid through the pipe outlet end) may be continuously, or substantially continuously, modified such as to maintain a substantially constant desired sewage fluid level (between a lower threshold level of the sewage fluid and an upper sewage level of the sewage fluid) in the upstream sewer pit. The required degree of opening may be determined by the controller based on sewage fluid level (in the upstream sewer pit) measurement data (obtained by the sensor and communicated to the controller). From continuous monitoring or repeated measurements of the sewage fluid level, the rate of change of the sewage fluid level may be computed. From the (current) measured sewage fluid level, and the measured rate of change thereof, the degree to which the valve should be further opened/closed, in order to lower/raise the sewage fluid surface to the desired level, may be determined by custom software in the controller.

According to some embodiments, the outflow of sewage fluid through the pipe outlet end is regulated such that when the sewage fluid level in the upstream sewer pit reaches a (lower) threshold level or is below the threshold level, the pipe inlet end and the pipe outlet end are fluidly disconnected (by shutting the valve) and the flow of sewage fluid from the upstream sewer pit to the discharge site is stopped. According to some embodiments, the valve is shut when the sewage fluid level in the upstream sewer pit drops to 5 cm above the pipe inlet end (or an uppermost part thereof, for example and as depicted in FIG. 2c, when the cross-section defining the pipe inlet end is slanted, that is, the cross-section is not horizontal). According to some embodiments, the valve is shut when the sewage fluid level in the upstream sewer pit drops to 2 cm, or even 1 cm, above the pipe inlet end.

According to some embodiments, when the sewage fluid level in the upstream sewer pit reaches an upper threshold level or is above the upper threshold level, the valve is opened to the maximum. According to some embodiments, the valve is opened to the maximum when the sewage fluid level rises to about 1 m above the pipe inlet end.

The lower threshold level may be pre-determined (e.g. prior to the initiation of the sewer bypass system during installation thereof) according to the measurements or geometry of the pipe inlet end, and optionally the geometry of the sewer pit floor or ground. In particular, the lower threshold level is selected to be as low as possible (e.g. 5 cm above the pipe inlet end or a topmost part thereof), while at the same time ensuring that air does not enter the pipe inlet end. More specifically, the lower threshold level is a “safety level” selected such that at all sewage fluid levels above the lower threshold level (when the flow control valve at the pipe outlet end is open or partially open) no air will enter the pipe inlet end (e.g. due to disturbances to the evenness or regularity of the sewage fluid surface brought about by eddies and vortices caused by the inflow of the sewage fluid into the pipe inlet end). The upper threshold level can be determined in an iterative manner as part of a calibration of the sewer bypass system following the installation thereof. The upper threshold level is selected to be as low as possible (so as to maximally reduce chances of overflow in the upstream sewer pit) while concurrently allowing sufficient time for the flow control valve to shut in case of a rapid decrease in the sewage fluid level (so as to ensure that air does not enter the pipe inlet end if the sewage fluid level quickly drops below the lower threshold level). According to some embodiments, the upper threshold level may be, for example, 1 m above the lower threshold level, 0.5 m above the lower threshold level, or even 0.2 m above the lower threshold level. The upper threshold level may also be changed during sewer bypass system operation (i.e. after installation and calibration).

As used herein, according to some embodiments, the terms “pre-determined level” and “lower threshold level”, with reference to the sewage fluid level in the upstream sewer pit, are used interchangeably.

Step 305 may be effected by mounting a blocking member (such as blocking member 250 in FIGS. 2a-2b), e.g. at an upstream end of the tunnel section leading downstream from the upstream sewer pit.

Step 315 may be effected by filling a pipe, such as pipe 202, with fluid from an external fluid (water) source when a flow control valve (such as valve 208 or valve 208c) at, or near, the pipe outlet end, is shut. The filling of the fluid may be effected via a fill opening, such as fill opening 236 or 236c. The pipe is filled with fluid until the fluid is observed to exit via the pipe inlet end, at which point the flow control valve is gradually opened until the flow is reversed and fluid is observed to exit via the pipe outlet end. The filling of the pipe with fluid may also be effected by suction via the fill opening (that is, application of negative pressure at the fill opening using e.g. a vacuum pump), thereby drawing sewage fluid from the upstream sewer pit into the pipe. When the sewage fluid reaches the fill opening, the fill opening is gradually shut while simultaneously gradually opening the flow control valve.

The filling opening may also function to expel gases (e.g. air) from the pipe during operation of the sewer bypass system.

As used herein, according to some embodiments, “flow control valve” and “flow regulated valve” are used interchangeably.

As used herein, according to some embodiments, “sequentially” with respect to a set of operations, e.g. measurements, refers to a series of operations (e.g. of the same type) such that the first operation in the series is performed first, the second operation in the series is performed after the first but before all the other operations in the series, and so on. In particular, a set of operations may be sequential even when the operations are not performed successively, in the sense of there being operations, which are not part of the set, which are performed in between operations in the set.

According to an aspect of some embodiments, there is provided a method of providing a sewer bypass, in a sewer line having a manhole with an interior comprising a sewage, a manhole service opening at its top, a manhole sewage inlet and a manhole sewage outlet adjacent its bottom, using a site external to the manhole. The method includes:
Connecting the manhole's interior with an external site by a pipe passing through the manhole service opening and having a pipe inlet end and a pipe outlet end, with the pipe inlet end being positioned inside the sewage and the pipe outlet end being positioned at the external site so as to allow the flow of sewage from the interior of the manhole along the pipe to the external site solely by the rule of communicating vessels.
At least reducing, or optionally, preventing the flow of the sewage out of the manhole outlet.
Constantly performing measurements of a parameter indicative of a difference between a current level of the sewage in the manhole interior and a pre-determined level of the sewage.
Regulating the outflow from the pipe outlet end according to the measurements, first, to make sure that the level of sewage within the manhole interior is such that the pipe inlet end is constantly sunken within the sewage and, second, that the level of sewage in said manhole interior is higher than that at the external site.

According to some embodiments, the manhole is a first manhole and the external site is a second manhole having a second interior for accommodating the sewage.

According to some embodiments, the external site is a sewage reservoir.

According to some embodiments, the regulation of the outflow from the pipe outlet end is performed by a tap switchable at least between an open state and a closed state.

According to some embodiments, the measuring is performed by a sensing arrangement.

According to an aspect of some embodiments, there is provided a system for providing a sewer bypass in a sewer line having a manhole with an interior comprising said sewage, a manhole inlet and a manhole outlet. The system includes:
at least one pipe having a pipe inlet end and a pipe outlet end, and having characteristics suitable for using the pipe to provide fluid communication between the interior of the manhole with the sewage, and an external site;
a sensing arrangement configured to be so mounted relative to the manhole interior as to be able to perform measurements of a parameter indicative of a difference between a current level of the sewage in the interior and a pre-determined level of the sewage; and
a tap configured to be mounted to the pipe closer to the pipe outlet end than to the pipe inlet end, at a lower level than the level of sewage in the manhole, and to regulate the outflow from the pipe outlet end, according to the measurements.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although steps of methods according to some embodiments may be described in a specific sequence, methods of the invention may comprise some or all of the described steps carried out in a different order. A method of the invention may comprise all of the steps described or only a few of the described steps. No particular step in a disclosed method is to be considered an essential step of that method, unless explicitly specified as such.

Although the invention is described in conjunction with specific embodiments thereof, it is evident that numerous alternatives, modifications and variations that are apparent to those skilled in the art may exist. Accordingly, the invention embraces all such alternatives, modifications and variations that fall within the scope of the appended claims. It is to be understood that the invention is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the invention. Section headings are used herein to ease understanding of the specification and should not be construed as necessarily limiting.

What is claimed is:

1. A sewer bypass system for diverting sewage fluid from an upstream sewer pit in a sewer system to a discharge site, the sewer bypass system comprising a pipe, a sensor, a controller, and a flow control valve;
wherein the pipe comprises a pipe inlet end and a pipe outlet end, and is configured to be partially inserted into an upstream sewer pit through a top opening of the upstream sewer pit with the pipe inlet end being submerged in a sewage fluid in the upstream sewer pit, and with the pipe outlet end being positioned at a discharge site, such that the pipe outlet end is lower than a sewage fluid surface in the upstream sewer pit;
wherein the sensor is external to the pipe and is configured to measure at least one parameter indicative of a sewage fluid level in the upstream sewer pit;
wherein the flow control valve is positioned at, or near, the pipe outlet end, and is configured to allow controllably fluidly connecting and disconnecting the upstream sewer pit to the discharge site; and
wherein the controller is functionally associated with the sensor and the flow control valve, the controller being configured to (i) receive a measured value of the parameter from the sensor and, based, at least in part, on the measured value, (ii) regulate the opening and closing of the flow control valve.

2. The sewer bypass system of claim 1, wherein the sensor is mounted on the exterior of the pipe such as to be positioned within the upstream sewer pit, and wherein the sensor is a level sensor mounted above the sewage fluid.

3. The sewer bypass system of claim 2, wherein the sensor is an ultrasonic sensor or a laser sensor, configured to measure the distance therefrom to the sewage fluid.

4. The sewer bypass system of claim 3, wherein the controller is configured to compute a rate of change in the sewage fluid level from sequentially measured values of the parameter; and
wherein the controller is further configured to regulate a degree of opening/closing of the flow control valve such as to maintain the degree of opening correlated with the computed rate of change; or
wherein the controller is further configured to, if the computed rate of change reaches or crosses a threshold rate of change, command the flow control valve to modify the degree of opening/closing thereof.

5. The sewer bypass system of claim 3, wherein the flow control valve comprises an actuator, configured to regulate the opening and closing of a valve member of the flow control valve; and
wherein the controller is configured to instruct the actuator to open the valve member as function of a difference between the measured sewage fluid level and a lower threshold level such that a degree of opening of the valve member increases with the difference, and wherein (i) if the sewage fluid level drops to, or below, the lower threshold level, the valve member is shut, and (ii) if the sewage fluid level rises to, or above, an upper threshold level, the valve member is fully opened.

6. The sewer bypass system of claim 5, wherein the sensor is configured to continuously monitor the parameter indicative of the sewage fluid level.

7. The sewer bypass system of claim 6, wherein the discharge site is located in a downstream sewer pit of the sewer system.

8. The sewer bypass system of claim 7, wherein, when the flow control valve is fully open, a full cross-section of the pipe is fully unblocked or substantially fully unblocked.

9. The sewer bypass system of claim 8, further comprising a blocking member mounted in the sewer system such as to prevent flow of the sewage fluid from the upstream sewer pit downstream along the sewer system.

10. The sewer bypass system of claim 9, wherein the pipe is configured for conveying sewage fluids comprising solid waste.

11. The sewer by pass system of claim 6, wherein the controller comprises two control modules: a first control module, located near or in the upstream sewer pit, and a second control module, located near or at the discharge site; and
wherein the control modules are wirelessly communicatively associated, and wherein the first control module is functionally associated with the sensor and the second control module is functionally associated with the flow control valve.

12. The sewer bypass system of claim 10, wherein the pipe comprises an above-ground portion.

13. A method for diverting sewage fluid from an upstream sewer pit in a sewer system to a discharge site, the method comprising steps of:
establishing a controllable fluid connection between an upstream sewer pit and a discharge site, via a pipe, partially inserted into the upstream sewer pit through a top opening of the upstream sewer pit, with a pipe inlet end being submerged in a sewage fluid in the upstream sewer pit, and with a pipe outlet end being positioned at the discharge site, such as to be lower than a sewage fluid level in the upstream sewer pit;
measuring at least one parameter indicative of the sewage fluid level in the upstream sewer pit using a sensor external to the pipe; and
regulating an outflow of the sewage fluid from the pipe outlet end based, at least in part, on one or more measured values of the parameter, wherein the sewage fluid is gravity-conveyed from the upstream sewer pit.

14. The method of claim 13, wherein the outflow of the sewage fluid from the pipe outlet end is regulated by a controller-commanded flow control valve, and wherein the sensor is configured to send measurement data of the at least one parameter to a controller which commands the flow control valve.

15. The method of claim 14, wherein the step of measuring the at least one parameter and the step of regulating the outflow are performed continuously.

16. The method of claim 15, wherein the sensor is a level sensor mounted above the sewage fluid.

17. The method of claim 16, wherein the parameter is a distance between the sensor and the sewage fluid level in the upstream sewer pit, and wherein the sensor is an ultrasonic sensor or a laser sensor, configured to measure the distance therefrom to the sewage fluid.

18. The method of claim 17, wherein the discharge site is a downstream sewer pit at a downstream end of the tunnel section.

19. The method of claim 17, wherein the step of regulating the outflow comprises computing a rate of change in the sewage fluid level from sequentially measured values of the parameter, obtained in repetitions, or continuous effecting, of the step of measuring the parameter, and wherein the outflow is determined based, at least in part, on the computed rate of change.

20. The method of claim 17, wherein the step of regulating the outflow comprises computing the sewage fluid level from the measured value of the parameter in the step of measuring the parameter, wherein the flow control valve is commanded to open as a function of a difference between the computed sewage fluid level and a lower threshold level such that a degree of opening of the flow control valve increases with the difference, and wherein (i) if the sewage fluid level drops to, or below, the lower threshold level, the flow control valve is closed, and (ii) if the sewage fluid level rises to, or above, an upper threshold level, the flow control valve is fully opened.
